(19) United States
(12) Patent Application Publication
(10) Pub. No.: US 2015/0138585 A1
(43) Pub. Date: May 21, 2015

(54) PRINTING MANAGEMENT SYSTEM, PRINTING MANAGEMENT METHOD, AND IMAGE FORMING APPARATUS

(71) Applicants: Toshiba Tec Kabushiki Kaisha, Tokyo (JP); Kabushiki Kaisha Toshiba, Tokyo (JP)

(72) Inventor: SHUNGO MIYATA, Shizuoka-ken (JP)

(73) Assignees: Toshiba Tec Kabushiki Kaisha, Tokyo (JP); Kabushiki Kaisha Toshiba, Tokyo (JP)

(21) Appl. No.: 14/084,473

(22) Filed: Nov. 19, 2013

(51) Int. Cl. H04N 1/32; H04N 1/00

(52) U.S. Cl. CPC H04N 1/32545; H04N 1/00408; H04N 1/00347; H04N 1/00832; H04N 1/00925; H04N 1/00933; H04N 1/00954; H04N 1/32523; H04N 2201/0094
USPC 358/1.14

(57) ABSTRACT

A printing management system comprises a count value calculation unit configured to, when a request for printing data of the specific user is received, read out the printing data and calculate a count value based on a number of sheets to fog printed in the printing data, a determination unit configured to determine whether a sum of the calculated count value and a previous cumulative count value is equal to or less than a limit value, and a printing data transmission unit configured to transmit the printing data when the sum is equal or less than the limit value. The count value is the product of the number of sheets to be printed in the printing data and one of a plurality of coefficients, and the one of the plurality of coefficients corresponds to a current one of a plurality of time zones.

### FIELD

Embodiments described herein relate generally to a printing management system, a printing management method, and an image forming apparatus.

### BACKGROUND

An apparatus referred to as a Multi-Function Peripheral (MFP) is known in the art. The MFP is a digital multifunction machine having a plurality of functions such as a scanning function, a FAX function, an image data storing function, and a copying function.

Conventionally, in managing the use of an image forming apparatus, quota management has been used. The quota management is a management method where the number of times that an image forming apparatus is used—such as the number of sheets to be printed by the image forming apparatus or the number of times of copying—is limited for every user or every division, for example.

However, in operating the quota management, it is necessary to operate the quota management such that the number of times of use of the image forming apparatus is changed corresponding to a situation where the image forming apparatus is used.

In a situation where a plurality of image forming apparatuses are installed, there may be a case where the use is focused on the image forming apparatus having high functions or the linage forming apparatus having high availability. Thus, uniform use of the plurality of image forming apparatus is hampered. Further, due to reasons relating to businesses, there may be a case where it is required to assign the priority in using the image forming apparatus to a specific user or a specific division for a specific timing.

### DESCRIPTION OF THE DRAWINGS

FIG. 1 illustrates a printing management system, according to a first embodiment.

FIG. 2 is an external view of an image forming apparatus, according to the first embodiment.

FIG. 3 illustrates a control system of an image forming system, according to the first embodiment.

FIG. 4 illustrates a display flow for a setting screen in the printing management system, according to the first embodiment.

FIG. 5 illustrates an all-user setting screen of the printing management system.

FIG. 6 illustrates a setting screen for an individual user of the printing management system.

FIG. 7 is a flowchart shoving printing management steps executed by the printing management system, according to the first embodiment.

FIG. 8 illustrates a printing execution instruction screen displayed on a control panel of the image forming apparatus of the first embodiment.

FIG. 9 illustrates a printing state detail screen displayed on the control panel of the image forming apparatus of the first embodiment.

FIG. 10 illustrates a display flow of a setting screen of a printing management system, according to a second embodiment.

FIG. 11 is a flowchart showing printing management steps executed by the printing management system of the second embodiment.

FIG. 12 illustrates a machine body setting screen for an individual user of a printing management system, according to a third embodiment.

### DETAILED DESCRIPTION

A printing management system according to an embodiment comprises a server and an image forming apparatus including a request transmission unit configured to transmit a request to the server for printing data of a specific user, and a printing unit configured to execute printing based on the printing data transmitted from the server in response to the request. The server is in communication with the image forming apparatus and includes a storage device, a count value calculation unit configured to, when the request for printing data of the specific user is received, read out the printing data from the storage device and calculate a count value based on a number of sheets to be printed in the printing data, a determination unit configured to determine whether a sum of the calculated count value and a previous cumulative count value is equal to or less than a limit value, and a printing data transmission unit configured to transmit the printing data to the image forming apparatus when the sum is equal or less than the limit value. The count value is the product of the number of sheets to be printed in the printing data and one of a plurality of coefficients, and the one of the plurality of coefficients corresponds to a current one of a plurality of time zones.

### First Embodiment

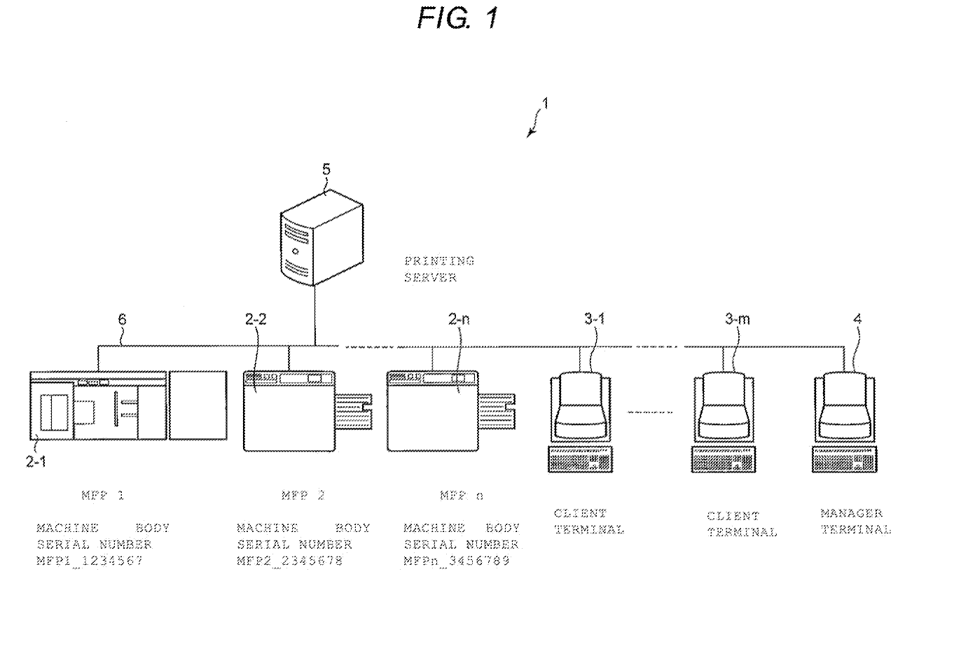

FIG. 1 illustrates a printing management system 1. The printing management system 1 includes at least one image forming apparatus 2 (2-1, 2-2, . . . , 2-n), client terminals 3 (3-1, . . . , 3-m), a manager terminal 4 and a printing server 5. These parts communicate with each other through a communication line 6.

The image forming apparatus 2 is a digital multi-function peripheral (referred to as an MFP), and is an apparatus having a plurality of functions such as, for example, a function of a copying machine, a function of a scanner, a function of a FAX machine and a function of an image data recording device (BOX device), all in one single device.

The client terminal 3 is an information processing terminal on which a user prepares image information, instruction information and the like for making the image forming apparatus 2 perform printing. Based on user instruction, the client terminal 3 transmits such information to the image forming apparatus 2. The manager terminal 4 is an information processing terminal which a manager of the printing management system 1 uses. Management information regarding printing management is prepared on manager terminal 4 and transmitted to the printing server 5. The client terminal 3 and the manager terminal 4 are not limited to an installation-type information processing terminal. Such terminals 3 and 4 may include a mobile Personal Computer (PC), a personal digital assistant and the like.

The printing server 5 stores information regarding users, executes a user authentication, and executes quota management.

The communication line 6 is a path used for transmission and reception of information, in a broad sense. In other words, the communication over communication line 6 is not limited to communication using a wire such as a conductive line or an optical fiber, and also includes wireless communication using light, a sound wave, an electric wave or the like.

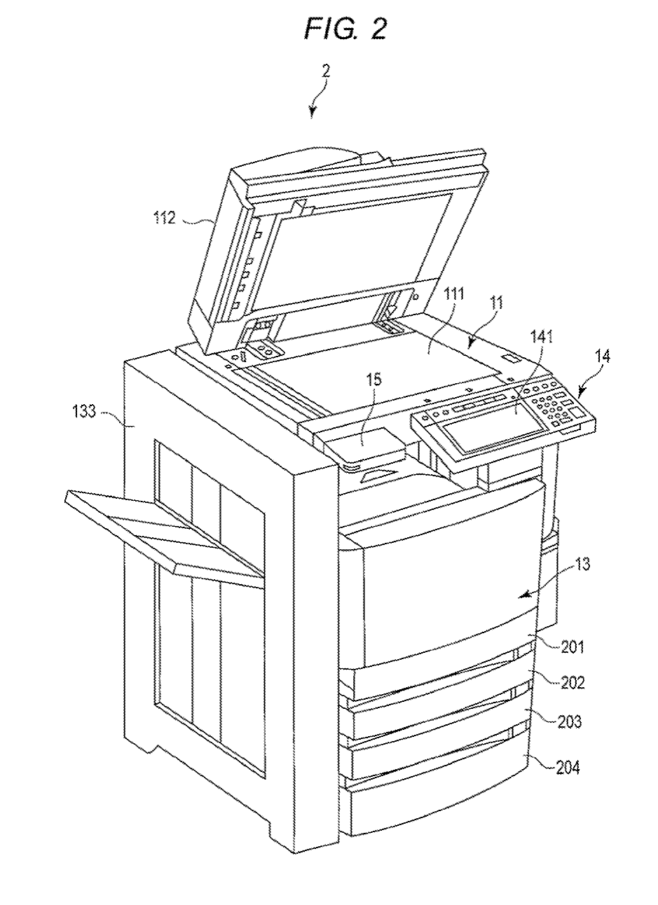

FIG. 2 is an external view of an image forming apparatus of the first embodiment. The image forming apparatus 2 includes a scanner 11, a printer 13, a control panel 14 and a card reader 15.

The scanner 11 is mounted on an upper portion of a body of the image forming apparatus 2. The scanner 11 is a device for optically reading an image on a document. For example, the scanner 11 reads an image on the whole document placed on a document platen 111. The scanner 11 also includes an auto document feeder (ADF) 112. The ADF 112 feeds sheet-like documents one by one. The scanner 11 reads an image on a document fed by the ADF 112.

The control panel 14 is mounted on a front portion of the upper surface of the body of the image forming apparatus 2. The control panel 14 displays the guidance to a user and receives instruction input from a user.

The control panel 14 includes various operation keys, displays and the like. For example, the control panel 14 includes a touch panel display 141 which is used as a touch-panel input and display device. In displaying various information on the image forming apparatus 2 or inputting various information into the image forming apparatus 2, a user touches icons displayed on the touch panel display 141 or operates operation keys while confirming information displayed on the touch panel display 141 so as to input desired instructions.

The card reader 15 is mounted on a front portion of the upper surface of the body of the image forming apparatus 2. The card reader 15 reads information stored in an ID card.

The printer 13 includes a paper feeding mechanism, a printing mechanism, a post-processing mechanism and the like. The paper feeding mechanism accommodates recording media, which are media on which an image is formed, such as paper (hereinafter referred to as paper) therein. The paper feeding mechanism feeds the paper to the printing mechanism one by one. The printing mechanism forms an image on the paper fed by the paper feeding mechanism. For the printing mechanism, various printing systems—such as an electrophotographic system, an ink jet system or a thermal transfer system—may be used.

The printer 13 includes feeding cassettes 201, 202, 203, 204. These feeding cassettes 201, 202, 203, 204 respectively accommodate papers which are subjected to printing processing by the printing mechanism.

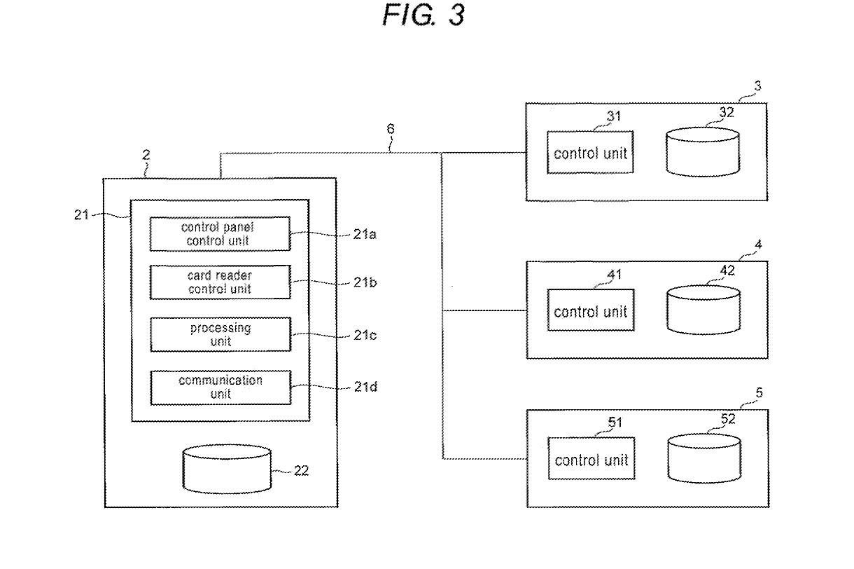

FIG. 3 illustrates a control system of the image forming System. With respect to the image forming apparatuses 2 and the client terminals 3, for the sake of brevity, the explanation is made in conjunction with the case where the only one image forming apparatus 2 and only one client terminal 3 are used.

The image forming apparatus 2 includes a control unit 21 and a storage device 22. The control unit 21 controls all operations of the image forming apparatus 2. The storage device 22 is a storage medium which is installed in the image forming apparatus 2. In the storage device 22, image files, various setting information and the like are stored.

The control unit 21 includes: a control panel control unit 21a; a card reader control unit 21b; a processing unit 21c; and a communication unit 21d. The control panel control unit 21a controls information transmission/reception operation between the control panel 14 and the control panel control unit 21a. The card reader control unit 21b reads information from an ID card by controlling the card reader 15. The processing unit 21c executes processing of a job of the image forming apparatus 2, and executes processing relating to printing management. The communication unit 21d controls transmission/reception of information between the communication processing unit 21d and the client terminal 3, the manager terminal 4 and the printing server 5 through the communication line 6.

The client terminal 3 includes a control unit 31 and a storage device 32. The control unit 31 controls all operations of the client terminal 3. The storage device 32 is a storage medium installed in the client terminal 3. In the storage device 32, information relating to users, image files and the like are stored.

The manager terminal 4 includes a control unit 41 and a storage device 42. The control unit 41 controls all operations of the manager terminal 4. The storage device 42 is a storage medium installed in the manager terminal 4.

The printing server 5 includes a control unit 51 and a printing management DB 52. The control unit 51 controls all operations of the printing server 5. The printing management DB 52 is a storage medium installed in the printing server 5. In the printing management DB 52, information necessary for executing authentication and printing management for respective users is stored.

Subsequently, the manner of operation of the printing management system of the first embodiment is explained.

The manager of the printing management system 1 inputs settings for the printing management in advance using the manager terminal 4.

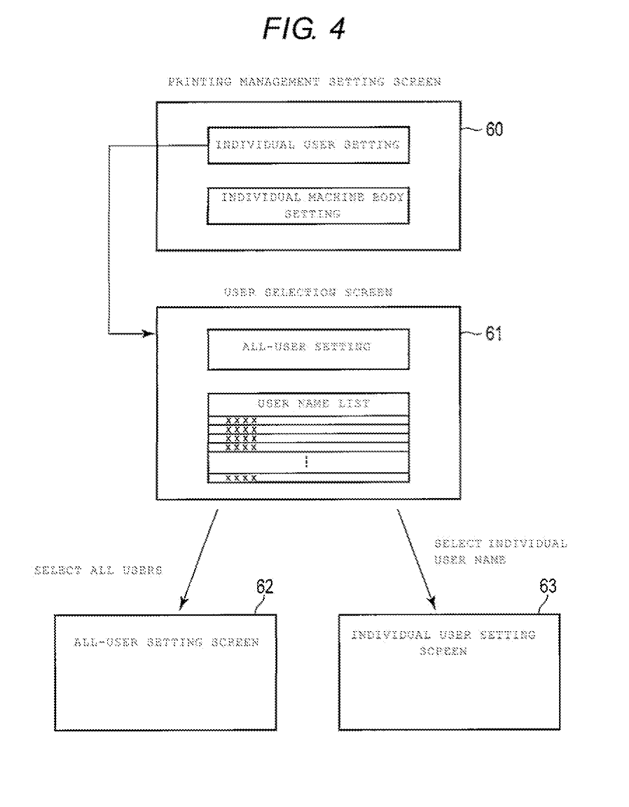

FIG. 4 snows a display flow of setting screens of the printing management system, according to the first embodiment.

When the manager starts using the manager terminal 4, the control unit 41 displays a printing management setting screen 60 on the manager terminal 4. When the manager selects the “individual user setting” icon on the printing management setting screen 60, the control unit 41 displays a user selection screen 61.

An “all-user setting” icon is displayed on the user selecting screen 61; also icons indicating user names are displayed as a list. When the manager selects the “all-user setting” icon on the user selecting screen 61, the control unit 41 displays an all-user setting screen 62. When the manager designates an icon of individual user name on the user selecting screen 61, the control unit 41 displays an individual user setting screen 63 corresponding to the user designated on the user selecting screen 61.

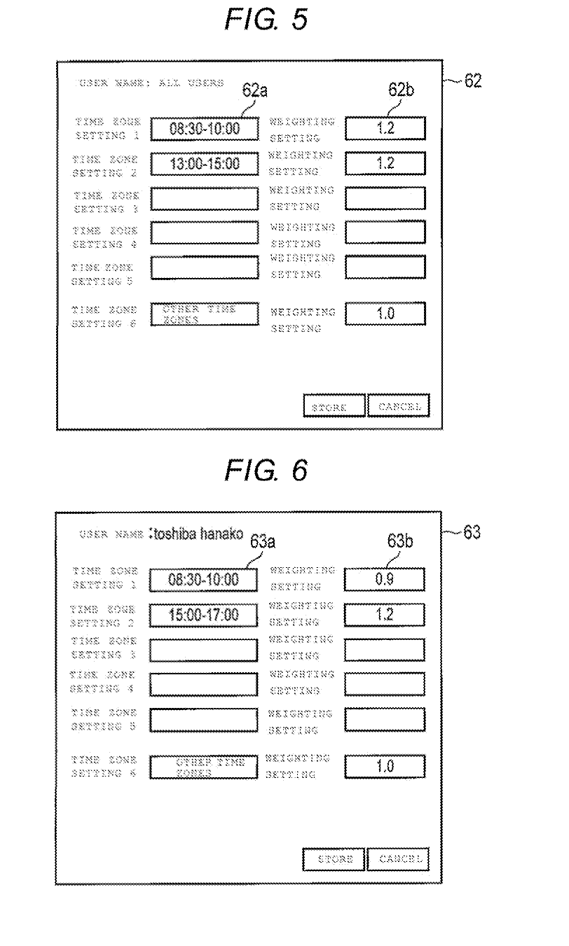

FIG. 5 illustrates the all-user setting screen 62 of the printing management system.

A plurality of time zone setting columns 62a and a plurality of weighting setting columns 62b are displayed on the all-user setting screen 62. The manager can select a time zone from a pull-down menu in the time zone setting columns 62a. The manager can select “other time zones” from the pull-down menu. The manager sets a “weighting coefficient value” in the weighting setting column 62b corresponding to the selected time zone.

The time cone setting and the weighting setting performed by the manager are now explained.

As described previously, the number of times that the image forming apparatus is used (i.e., the number of sheets to be printed by the image forming apparatus or the number of times of copying) may be limited for every user or for every division, according to monthly limits, for example. In this embodiment, the limited number of sheets to be printed is referred to as “print limit number.” The number of sheets is counted up each time color printing or monochromic printing is executed. In counting up the number of sheets, a weighting factor is applied to a count value, where the weighting factor corresponds to a size of the sheet. For example, in the case where printing is executed, using a sheet having a large size (A3 paper sheet or the like), even when one sheet is printed, the count number is multiplied by a size coefficient of 2.2 so that the count value is not set to 1 but to 2.2.

In this embodiment, a count value for every printing is acquired by further multiplying such a count value to which weighting is applied by a weighting coefficient corresponding to a time zone. A cumulative value of the count values must be within the print limit number. That is, assuming a count value for every printing as Ci, a weighting coefficient corresponding to a time zone as α, a count value for every printing in accordance with a conventional system as Ki, a cumulative count value as Ai, and the print limit number as Li, the relationships expressed by the following formulae (1) to (3) are established.

Ci=α×Ki (1)

Ai=ΣCi (2)

Li≧Ai (3)

In an example shown in FIG. 5, the weighting coefficient α is set to 1.2 (α=1.2) when printing is executed in a time zone from 8:30 to 10:00 with respect to all users. The weighting coefficient α is set to 1.2 (α=1.2) when printing is executed in a time zone from 13:00 to 15:00 with respect to all users. The weighting coefficient α is set to 1.0 (α=1.0) when printing is executed in other time zones with respect to all users. Accordingly, in the setting example shown in FIG. 5, the setting is made by the manager such that users are encouraged to refrain from printing in the time zone where the weighting coefficient α is set to 1.2 (α=1.2).

FIG. 6 is an exemplary view showing the individual user setting screen 63 of the printing management system of the first embodiment.

The user name is displayed on the individual user setting screen 63. Also, in the same manner as the all-user setting screen 62, a plurality of time zone setting columns 63a and a plurality of weighting setting columns 63b are displayed on the individual user setting screen 63. The manager can select a time zone from a pull-down menu in the time zone setting columns 63a. The manager can select “other time zones” from this pull-down menu. The manager sets a “weighting coefficient value” in the weighting setting column 63b corresponding to the time zone selected by the manager.

In the example shown in FIG. 6, the weighting coefficient α is set to 0.9 (α=0.9) when printing is executed in a time zone from 8:30 to 10:00 by the user. The weighting coefficient α is set to 1.2 (α=1.2) when printing is executed in a time zone from 15:00 to 17:00 by the user. The weighting coefficient α is set to 1.0 (α=1.0) when printing is executed in other time zones by the user. Accordingly, in the setting example shown in FIG. 6, the setting is made by the manager so as to encourage the user to print in the time zone where the weighting coefficient α is set to 0.9 (α=0.9), and to encourage the user refrain from printing in the time zone where the weighting coefficient α is set to 1.2 (α=1.2).

The all-user setting screen 62 and the individual user setting screen 63 are provided for enhancing the efficiency of the setting operation. For example, in the case where the number of users who are encouraged to refrain from printing (which is set by the manager) is 195 and the number of users who are encouraged to perform printing (which is set by the manager) is 5, when the setting is made with respect to the respective users in 200 cases in total, such setting becomes an extremely laborious operation. In view of the above, firstly, the setting is made using the all-user setting screen 62 such that all users are encouraged to refrain (200 cases) from printing and, thereafter, the setting is made using the individual user setting screen 63 such that the users (5 cases) are encouraged to perform printing. Due to such setting, the setting operation can be performed efficiently.

When the manager performs the setting as described above and pushes a “store” button, the set information is transmitted to the printing server 5, and the control unit 51 of the printing server 5 stores the information in the printing management DB 52.

Then, an operation which a user performs in executing printing is explained.

The user edits image data by operating the client terminal 3, and inputs an instruction for the image forming apparatus 2 to execute printing. Due to such an operation, edited image data and a user name are transmitted to the printing server 5. In the printing server 5, the control unit 51 stores image data in a data region of the printing management DB 52 which corresponds to a transmitted user name.

Then, the manner of operation of printing management performed by the printing management system 1 is explained.

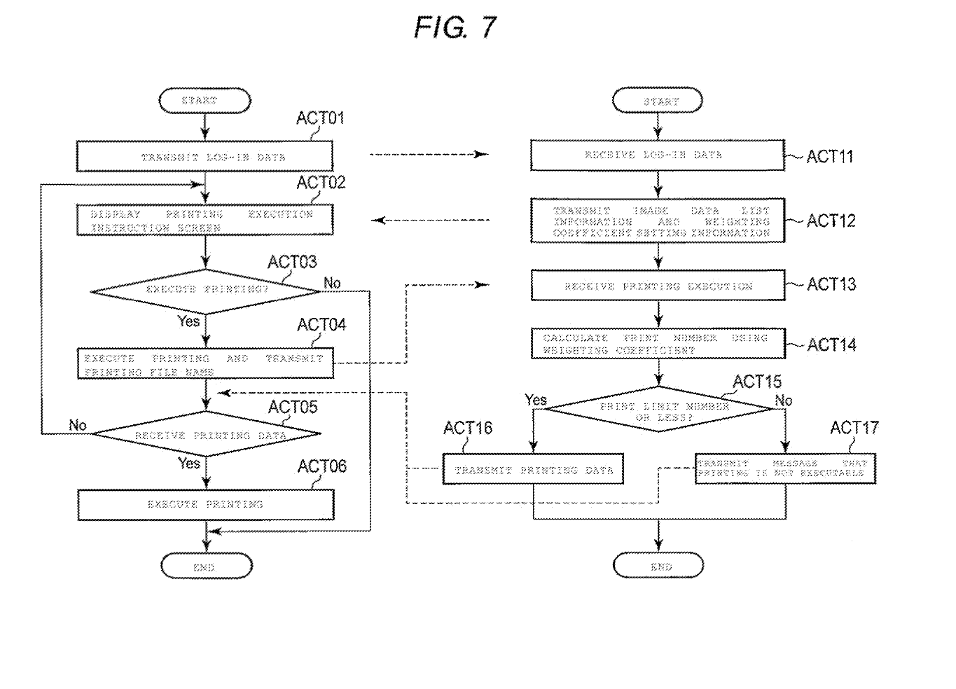

FIG. 7 is a flowchart showing the steps of printing management performed by the printing management system, according to the first embodiment.

To instruct a desired image forming apparatus 2 to perform printing of image data, a user logs into the image forming apparatus 2 by inputting a user name and a password using the control panel 14 of the image forming apparatus 2. In ACT 01, the processing unit 21c transmits the inputted user name and password to the printing server 5.

In ACT 11, the control unit 51 of the printing server 5 receives log-in data (user name, password) and performs the user authentication. When the user is authenticated, in ACT 12, the control unit 51 retrieves the printing management DB 52, extracts the weighting coefficient setting information for the user, the image data list information and the like, and transmits these information to the image forming apparatus 2.

In ACT 02, the processing unit 21c of the image forming apparatus 2 displays a printing execution instruction screen 70 on the touch panel display 141 of the control panel 14 based on data transmitted from, the printing server 5.

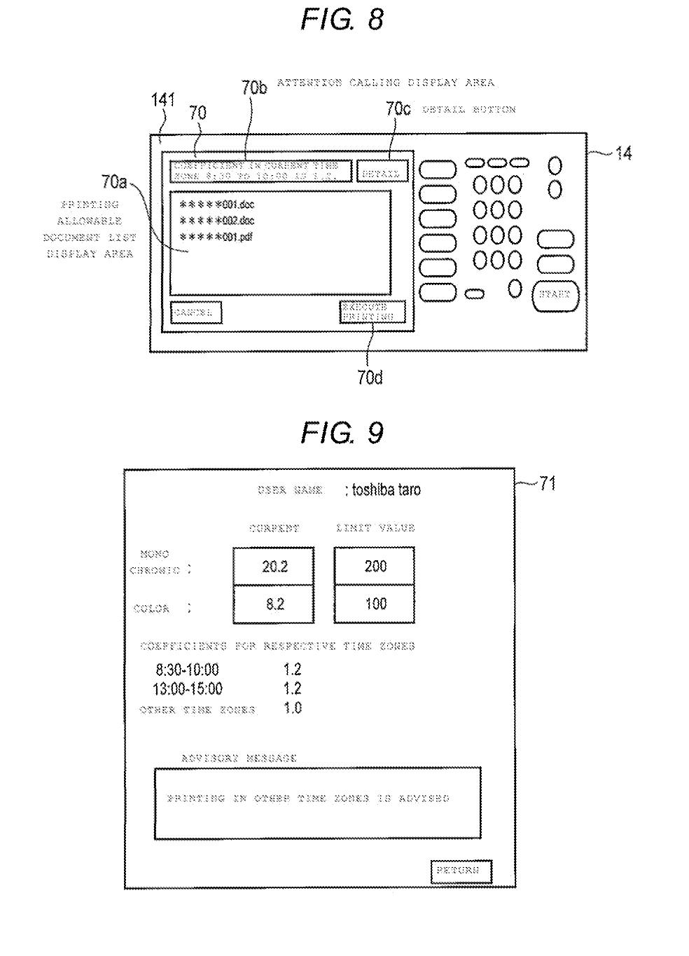

FIG. 8 illustrates the printing execution instruction screen 70 displayed on the control panel 14 of the image forming apparatus, according to the first embodiment.

On the printing execution instruction screen 70, a printing allowable document list display area 70a, an attention calling display area 70b, a detail button 70c, and a printing execution button 70d are displayed.

In the printing allowable document list display area 70a, file names of image data which the user can print are displayed as a list. On the attention calling display area 70b, an attention calling massage that a large weighting coefficient is used in a current time zone is displayed. When the user pushes the detail button 70c, a printing state detail screen 71 (described below) is displayed on the touch panel display 141. When the user selects one file name from the listed file names and pushes the printing execution button 70d, the user can print out image data.

FIG. 9 illustrates the printing state detail screen 71 displayed on the control panel 14 of the image forming apparatus of the first embodiment.

As described above, the printing state detail screen 71 is displayed by pushing the detail button 70c. On the printing state detail screen 71, a current count value and a print limit number value are displayed. By viewing such a display, the user can estimate whether or not printing at the current time will exceed the limit value. A weighting coefficient for the individual time zone (which the manager sets) is displayed. Further, in the case where a large weighting coefficient is allocated (i.e., for when printing is executed frequently), an advisory massage which advises the user to execute printing in a time zone where a large weighting coefficient is not used is displayed.

In ACT 03 shown in FIG. 7, the user determines whether or not to execute printing by reference to the printing execution instruction screen 70 and the printing state detail screen 71 displayed on the control panel 14. When the user stops the execution of printing (NO in ACT 03), this processing is finished. When the user pushes down the printing execution button 70d (YES in ACT 03), the processing unit 21c of the image forming apparatus 2 transmits the message that the printing execution instruction is made and the selected file name to the printing server 5 in ACT 04.

When the control unit 51 of the printing server 5 receives the printing execution instruction in ACT 13, the control unit 51 calculates the number of sheets to be printed (count value) using the weighting coefficient extracted from the printing management DB 52 in ACT 14. Then, the control unit 51 checks whether or not the cumulative number of printed sheets (cumulative count value) is the print limit number or less, in ACT 15.

When the cumulative number of printed sheets is the print limit number or less (YES in ACT 15), the control unit 51 stores the counted-up cumulative number of printed sheets in the printing management DB 52 in ACT 16, and transmits the printing data to the image forming apparatus 2. When the cumulative number of printed, sheets is larger than the print limit number (NO in ACT 15), the control unit 51 transmits a message that printing cannot be executed to the image forming apparatus 2 in ACT 17.

In ACT 05, the processing unit 21c of the image forming apparatus 2 checks whether or not printing data is transmitted from the printing server 5. When printing data is transmitted (YES in ACT 05), the processing unit 21c executes printing of transmitted data.

When the message that printing cannot be executed is transmitted (NO in ACT 05), the processing returns to ACT 02 where the processing unit 21c displays the printing execution instruction screen 70 on the touch panel display 141 of the control panel 14. On the attention calling display area 70b of the printing execution instruction screen 70, a message is displayed that the cumulative number of printed sheets exceeds the print limit number so that printing cannot be executed.

The user determines whether to stop printing or to execute printing based on another printing data by reference to the message, and executes processing in ACT 03 and subsequent steps. Since the processing in ACT 03 and subsequent steps have been already explained, their repeated explanation is omitted.

In the first embodiment, time zones can be set for every user. However, the time zones are not limited to times within one day described in the embodiment, and working days or non-working days (or weekdays, holidays) of a company may be designated for every user. For example, when the image forming apparatus is used during a holiday, a weighting coefficient may be lowered compared to the case where the image forming apparatus is used in a weekday.

### Second Embodiment

A second embodiment differs from the first embodiment in that, in the second embodiment, a weighting coefficient is set for an individual machine body (i.e., an image forming apparatus 2-n). In the second embodiment, parts having identical or similar functions as the functions of the corresponding parts in the first embodiment are given the same symbols and their detailed explanation is omitted.

A manager of a printing management system 1, who intends to execute the printing management, sets the printing management settings in advance, using a manager terminal 4.

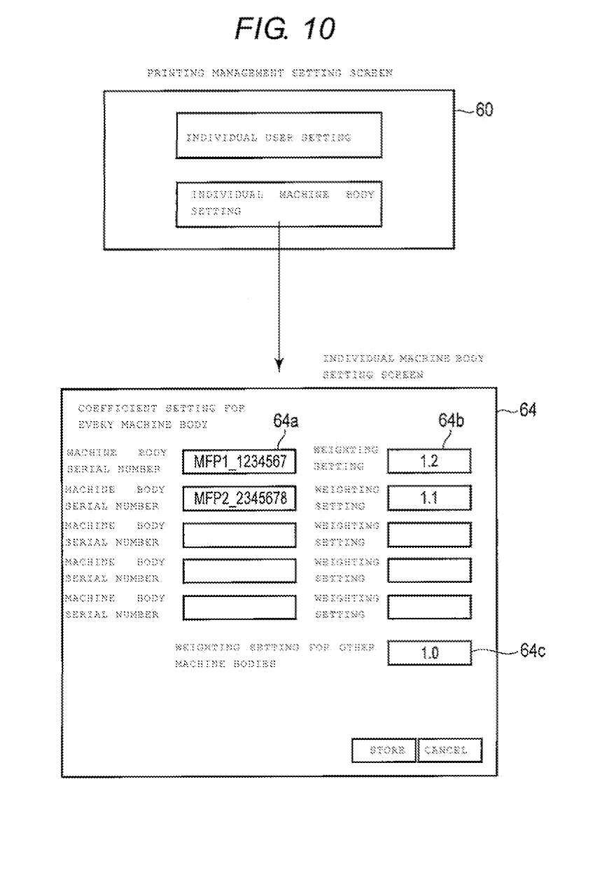

FIG. 10 illustrates a display flow of setting screens of the printing management system of the second embodiment.

When the manager starts using the manager terminal 4, the control unit 41 displays a printing management setting screen 60 on the manager terminal 4. When the manager selects a “setting for individual machine body” icon on the printing management setting screen 60, the control unit 41 displays a individual machine body setting screen 54.

A plurality of machine body serial number setting columns 64a and a plurality of weighting setting columns 64b are displayed on the individual machine body setting screen 64. The manager can select a machine body serial number from a pull-down menu in the machine body serial number setting column 64a. The manager sets a “weighting coefficient value” in the weighting setting column 64b corresponding to the selected machine body serial number. Here, with respect to image forming apparatuses having machine body serial numbers which are not selected by the manager, a “weighting coefficient value” is inputted to a weighting setting column 64c other than the above-mentioned columns.

In the example shown in FIG. 10, a weighting coefficient α is set to 1.2 (α=1.2) when printing is executed using the image forming apparatus 2 having a machine body serial number MFP1_{—}1234567. The weighting coefficient α is set to 1.1 (α=1.1) when printing is executed using the image forming apparatus 2 having a machine body serial number MFP2_{—}2345678. Accordingly, in the setting example shown in FIG. 10, the setting is made by the manager such that the users are encouraged to refrain from printing with respect to the image forming apparatuses 2 having machine body serial numbers where the weighting coefficient α is set to 1.2 and 1.1 (α=1.2, α=1.1).

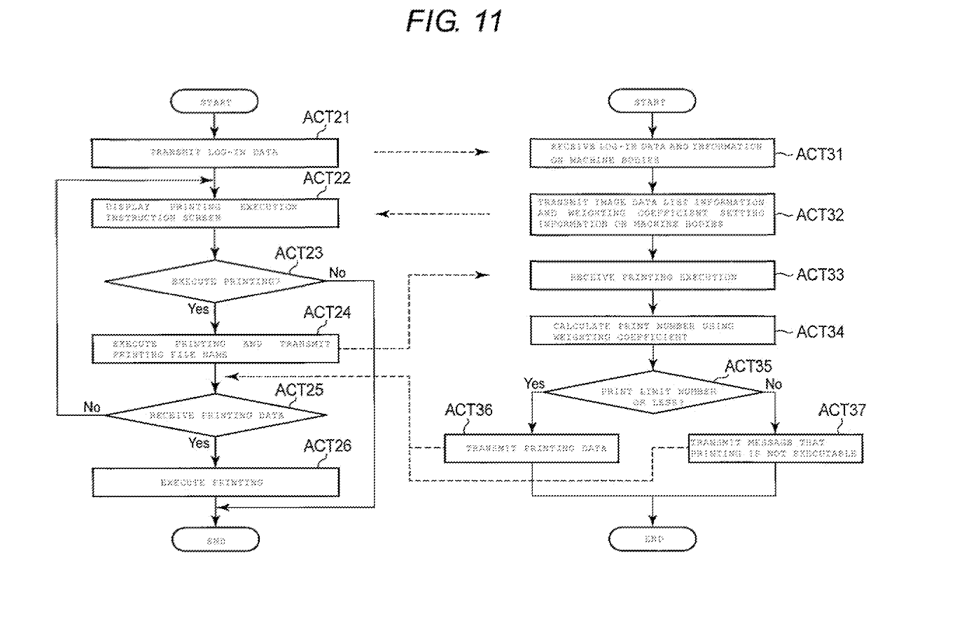

FIG. 11 is a flowchart showing the steps of printing management performed by the printing management system of the second embodiment.

To instruct a desired image forming apparatus 2 perform printing of image data, a user logs in the image forming apparatus 2 by inputting a user name and a password using a control panel 14 of the image forming apparatus 2. In ACT 21, a processing unit 21c transmits the inputted user name and password, and information on machine body (serial number, for example) to a printing server 5.

In ACT 31, a control unit 51 of the printing server 5 performs the user authentication using the log-in data (user name and password) which the printing server 5 receives. When the user is authenticated, in ACT 32, the control unit 51 retrieves a printing management DB 52, extracts weighting coefficient setting information on the corresponding machine body, the image data list information on the user and the like, and transmits these information to the image forming apparatus 2 which the user logs in.

In ACT 22, the processing unit 21c of the image forming apparatus 2 displays a printing execution instruction screen 70 on a touch panel display 141 of the control panel 14 based on data transmitted from the printing server 5.

When the user intends to execute printing using an image forming apparatus where a weighting coefficient is not less than 1, an alarm indicating that the weighting coefficient is not less than 1 is displayed, on an attention calling display area 70 of the printing execution instruction screen 70. Further, on a printing state detail screen (not shown), an advisory massage is displayed which specifically identifies an alternate image forming apparatus where the weighting coefficient is set to 1 or less and advises the user to use the alternate image forming apparatus. The user can perform the setting of printing again using another image forming apparatus by reference to these displays.

Processing steps other than the above-mentioned processing steps are equal to the corresponding steps of the first embodiment and hence, their detailed explanation is omitted.

In the second embodiment, a weighting coefficient is set for every machine body. However, besides the above-mentioned setting, a weighting coefficient may be set by designating a function which a machine body has. For example, the weighting coefficient may be set by designating a machine body having a copying speed not less than a predetermined value or a machine body including a finisher. In this case, the setting can be realized by making the printing server 5 store the specification for every machine body and by performing determination by collating the specification with identification information transmitted from the image forming apparatus 2.

### Third Embodiment

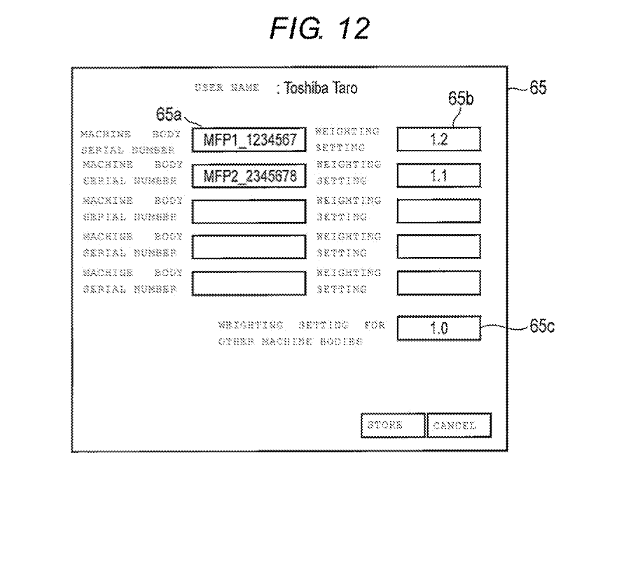

FIG. 12 illustrates a machine body setting screen 65 for an individual user of a printing management system, according to a third embodiment.

In the second embodiment, a weighting coefficient is set for every machine body. On the other hand, in the third embodiment, in the same manner as the first embodiment, a weighting coefficient can be set for every user (or division). In the third embodiment, in the same manner as the first embodiment, a machine body setting screen for individual users may be provided.

According to the third embodiment, it is possible to assign either the image forming apparatus whose use is limited or the image forming apparatus whose use is recommended to specific users.

Here, the respective functions explained in the above-mentioned embodiments may be constituted using hardware, or may be realized by allowing a computer to read programs in which the respective functions are written using software. Further, the respective functions may be constituted by suitably selecting either one of software and hardware.

Further, the respective functions may be also realized by allowing a computer to read a program stored in a recording medium not shown in the drawing. The recording medium according to this embodiment can adopt any recording method provided that the recording medium can record the program, and the program is computer readable.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printing management system comprising:
a server; and
an image forming apparatus including:
a request transmission unit configured to transmit a request to the server for printing data of a specific user, and
a printing unit configured to execute printing based on the printing data transmitted from the server in response to the request;
the server in communication with the image forming apparatus including:
a storage device,
a count value calculation unit configured to, when the request for printing data of the specific user is received, read out the printing data from the storage device and calculate a count value based on a number of sheets to be printed in the printing data;
a determination unit configured to determine whether a sum of the calculated count value and a previous cumulative count value is equal to or less than a limit value; and
a printing data transmission unit configured to transmit the printing data to the image forming apparatus when the sum is equal or less than the limit value,
wherein the count value is the product of the number of sheets to be printed in the printing data and one of a plurality of coefficients, and the one of the plurality of coefficients corresponds to a current one of a plurality of time zones.

2. The printing management system according to claim 1, wherein the one of the plurality of coefficients also corresponds to the specific user out of a plurality of users.

3. The printing management system according to claim 1, wherein:
the image forming apparatus comprises a plurality of image forming apparatuses, each having the request transmission unit and the printing unit; and
each of the plurality of coefficients also correspond to each of a plurality of image forming apparatuses.

4. The printing management system according to claim 1, wherein the image forming apparatus further comprises a display unit configured to display a message which advises the specific user to print during a different time zone if the one of the plurality of coefficients is more than 1.

5. The printing management system according to claim 4, wherein the one of the plurality of coefficients also corresponds to the specific user out of a plurality of users.

6. The printing management system according to claim 1, wherein at least one of the plurality of time zones is a high-use time zone, and the coefficient that corresponds to the high-use time zone is more than 1.

7. The printing management system according to claim 6, wherein an least one of the plurality of time zones is a low-use time tone, and the coefficient that corresponds to the low-use time zone is less than 1.

8. A printing management method of a printing management system including an image forming apparatus in communication with a server, the method comprising:
receiving a request from the image forming apparatus to the server for printing data of a specific user;
reading the printing data of a specific user from a storage device;
calculating a count value based on a number of sheets to be printed in the printing data; and
controlling printing of the print data based on whether a sum of the calculated count value and a previous cumulative count value is equal to or less than a limit value,
wherein the count value is the product of the number of sheets to be printed in the printing date and one of a plurality of coefficients, and the one of the plurality of coefficients corresponds to a current one of a plurality of time zones.

9. The printing management method according to claim 8, wherein the one of the plurality of coefficients also corresponds to the specific user out of a plurality of users.

10. The printing management method according to claim 8, wherein:
the image forming apparatus comprises a plurality of image forming apparatuses, each having the request transmission unit and the printing unit; and
each of the plurality of coefficients also correspond to each of a plurality of image forming apparatuses.

11. The printing management method according to claim 3, further comprising displaying a message which advises the specific user to print during a different time zone when the one of the plurality of coefficients is more than 1.

12. The printing management method according to claim 11, wherein the one of the plurality of coefficients also corresponds to the specific user out of a plurality of users.

13. The printing management method according to claim 8, wherein at least one of the plurality of time zones is a high-use time zone, and the coefficient that corresponds to the high-use time zone is more than 1.

14. The printing management method according to claim 13, wherein at least one of the plurality of time zones is a low-use time zone, and the coefficient that corresponds to the low-use time zone is less than 1.

15. A printing management method of a printing management system including a plurality of image forming apparatuses each in communication with a server, the method comprising:
receiving a request from the image forming apparatus to the server for printing data of a specific user;
reading the printing data of a specific user from a storage device;
calculating a count value based on a number of sheets to be printed in the printing data; and
controlling printing of the print data based on whether a sum of the calculated count value and a previous cumulative count value is equal to or less than a limit value, wherein
wherein the count value is the product of the number of sheets to be printed in the printing data and one of a plurality of coefficients, and each of the plurality of coefficients corresponds to each of a plurality of image forming apparatuses.

16. The printing management method according to claim 15, wherein the one of the plurality of coefficients also corresponds to the specific user out of a plurality of users.

17. The printing management method according to claim 15, wherein the one of the plurality of coefficients also corresponds to a current one of a plurality of time zones.

18. The printing management method according to claim 15, further comprising displaying a message which advises the specific user to print during a different time zone when the one of the plurality of coefficients is more than 1.

19. The printing management method according to claim 13, wherein the one of the plurality of coefficients also corresponds to the specific user out of a plurality of users.

20. The printing management method according to claim 1, wherein at least one of the plurality of time zones is a high-use time zone, and the coefficient that corresponds to the high-use time zone is more than 1.
